(19) United States
(12) Patent Application Publication
(10) Pub. No.: US 2023/0186138 A1
(43) Pub. Date: Jun. 15, 2023

(54) TRAINING OF QUANTUM NEURAL NETWORK

(71) Applicant: BEIJING BAIDU NETCOM SCIENCE TECHNOLOGY CO., LTD., Beijing (CN)

(72) Inventors: Xin WANG, Beijing (CN); Hongshun Yao, Beijing (CN); Sizhuo Yu, Beijing (CN); Xuanqiang Zhao, Beijing (CN)

(73) Assignee: BEIJING BAIDU NETCOM SCIENCE TECHNOLOGY CO., LTD., Beijing (CN)

(21) Appl. No.: 18/081,555

(22) Filed: Dec. 14, 2022

(30) Foreign Application Priority Data
Dec. 15, 2021 (CN) 202111533169.X

(51) Int. Cl. G06N 10/60; G06N 10/20

(52) U.S. Cl. CPC G06N 10/60; G06N 10/20

(57) ABSTRACT

A method is provided. The method includes: determining L+1 parameterized quantum circuits and L data encoding circuits; obtaining a plurality of training data pairs including independent variable data and dependent variable data. The method further includes, for each of the training data pairs: cascading the parameterized quantum circuits and the data encoding circuits alternately to form a quantum neural network, where the data encoding circuits code the independent variable data in the training data pair; and operating the quantum neural network from an initial quantum state and performing measurement on the output of the quantum neural network, to obtain a measurement result. The method further includes, computing a loss function based on measurement results corresponding to all the training data pairs and corresponding dependent variable data; and adjusting parameters to be trained of the parameterized quantum circuits and the data encoding circuits to minimize the loss function.

### CROSS REFERENCE TO RELATED APPLICATIONS

The present application claims priority to Chinese Patent Application No. 202111533169.X filed on Dec. 15, 2021, the contents of which is hereby incorporated by reference in its entirety for all purposes.

### TECHNICAL FIELD

The present disclosure relates to the field of computers, in particular to the technical field of quantum computers, and specifically to a quantum neural network training method and system, an electronic device, a computer-readable storage medium, and a computer program product.

### BACKGROUND

Many problems in daily production and life are problems of function simulation such as a stock trend forecast and a weather forecast. With the development of artificial intelligence technologies, a deep neural network (DNN) is widely used to solve the problems above. However, DNN models require a great number of parameters, and large-scale DNNs often require hundreds of millions of parameters. In addition, hyperparameters of the models are difficult to adjust, and are susceptible to overfitting in training.

As the quantum computing field has developed rapidly, recent quantum computing devices can already support experiments on some shallow quantum circuits. Therefore, how to use a quantum computing device to solve the problems above becomes critical.

### SUMMARY

The present disclosure provides a quantum neural network training method and system, an electronic device, a computer-readable storage medium, and a computer program product.

According to an aspect of the present disclosure, there is provided a quantum neural network training method, including: determining L+1 parameterized quantum circuits and L data encoding circuits, the parameterized quantum circuits and the data encoding circuits each including respective parameters to be trained, where L is a positive integer; obtaining a plurality of training data pairs, where each of the plurality of training data pairs includes independent variable data and dependent variable data related to the independent variable data, and where the independent variable data includes one or more data values; for each of the plurality of training data pairs, performing the following operations: cascading the L+1 parameterized quantum circuits and the L data encoding circuits alternately to form a quantum neural network, and causing each data encoding circuit in the quantum neural network to code the independent variable data in the training data pair; and operating the quantum neural network from an initial quantum state and performing measurement on the output of the quantum neural network by using a measurement method, to obtain a measurement result; computing a loss function based on the measurement results corresponding to all the training data pairs and corresponding dependent variable data; and adjusting the parameters to be trained of the L+1 parameterized quantum circuits and the L data encoding circuits to minimize the loss function.

According to another aspect of the present disclosure, there is provided an electronic device, including: a memory storing one or more programs configured to be executed by one or more processors, the one or more programs including instructions for causing the electronic device to perform operations comprising: determining L+1 parameterized quantum circuits and L data encoding circuits, the parameterized quantum circuits and the data encoding circuits each comprising a respective parameter to be trained, where L is a positive integer; obtaining a plurality of training data pairs, wherein each of the plurality of training data pairs comprises independent variable data and dependent variable data related to the independent variable data, and wherein the independent variable data comprises one or more data values; for each of the plurality of training data pairs, performing the following operations: cascading the L+1 parameterized quantum circuits and the L data encoding circuits alternately to form a quantum neural network, and causing each of the L data encoding circuits in the quantum neural network to encode the independent variable data in the training data pair; and operating the quantum neural network from an initial quantum state and performing measurement on the output of the quantum neural network by using a measurement method, to obtain a measurement result; computing a value of a loss function based on the measurement results corresponding to all the training data pairs and corresponding dependent variable data; and adjusting the parameters to be trained of the L+1 parameterized quantum circuits and the L data encoding circuits to minimize the value of the loss function.

According to another aspect of the present disclosure, there is provided a non-transitory computer-readable storage medium that stores one or more programs comprising instructions that, when executed by one or more processors of a computing device, cause the computing device to implement operations comprising: determining L+1 parameterized quantum circuits and L data encoding circuits, the parameterized quantum circuits and the data encoding circuits each comprising a respective parameter to be trained, where L is a positive integer; obtaining a plurality of training data pairs, wherein each of the plurality of training data pairs comprises independent variable data and dependent variable data related to the independent variable data, and wherein the independent variable data comprises one or more data values; for each of the plurality of training data pairs, performing the following operations: cascading the L+1 parameterized quantum circuits and the L data encoding circuits alternately to form a quantum neural network, and causing each of the L data encoding circuits in the quantum neural network to encode the independent variable data in the training data pair; and operating the quantum neural network from an initial quantum state and performing measurement on the output of the quantum neural network by using a measurement method, to obtain a measurement result; computing a value of a loss function based on the measurement results corresponding to all the training data pairs and corresponding dependent variable data; and adjusting the parameters to be trained of the L+1 parameterized quantum circuits and the L data encoding circuits to minimize the value of the loss function.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings exemplarily show embodiments and form a part of the specification, and are used to explain exemplary implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a flowchart of a quantum neural network training method according to an embodiment of the present disclosure;

FIG. 2 is a flowchart illustrating a process of computing a loss function based on measurement results in FIG. 1 according to an embodiment of the present disclosure;

FIG. 3 is a schematic diagram of a quantum neural network to be trained in an exemplary application according to an embodiment of the present disclosure;

FIG. 4 is a schematic diagram of a quantum neural network to be trained in another exemplary application according to an embodiment of the present disclosure;

FIG. 5 is a schematic comparison diagram of simulation results obtained based on the application shown in FIG. 4;

FIG. 6 is a structural block diagram of a quantum neural network training system according to an embodiment of the present disclosure; and

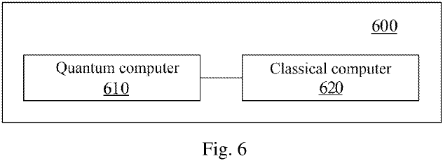

FIG. 7 is a structural block diagram of an exemplary electronic device that can be used to implement an embodiment of the present disclosure.

### DETAILED DESCRIPTION OF EMBODIMENTS

Embodiments of the present disclosure are described below with reference to the accompanying drawings, where various details of the embodiments of the present disclosure are included for a better understanding, and should be considered as merely example. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

The embodiments of the present disclosure will be described below in detail with reference to the accompanying drawings.

So far, various types of computers in application all use classical physics as a theoretical basis for information processing, and are referred to as conventional computers or classical computers. Binary data bits that are easiest to implement physically are used by a classical information system to store data or programs. Each binary data bit is represented by 0 or 1 and referred to as a bit, and is the smallest information unit. The classical computers themselves have the following disadvantages. First, the classical computers have the disadvantage associated with the most basic limitation of energy consumption in a computation process. Minimum energy required by a logic element or a storage unit should be several times more than kT (where k represents the Boltzmann constant and T represents the temperature) to avoid malfunction under thermal fluctuations. Second, the classical computers have the disadvantage associated with information entropy and heating energy consumption Third, under a very high routing density of computer chips, according to the Heisenberg’s uncertainty principle, if uncertainty of electronic positions is very low, uncertainty of a momentum can be very high. Electrons are no longer bound and this have a quantum interference effect that may even damage performance of chips.

Quantum computers are a type of physical devices that abide by the properties and laws of quantum mechanics to perform high-speed mathematical and logical computation, and store and process quantum information. When a device processes and computes quantum information and runs a quantum algorithm, the device is a quantum computer. The quantum computers abide by a unique quantum dynamics law (especially quantum interference) to implement a new mode of information processing. For parallel processing of computing problems, the quantum computers have an absolute advantage in speed than classical computers. A transformation of each superposition component performed by the quantum computers is equivalent to a classical computation. All these classical computations are completed simultaneously and superposed based on a specific probability amplitude, and an output result of the quantum computers is provided. Such computation is referred to as a quantum parallel computation. Quantum parallel processing greatly improves efficiency of the quantum computers and causes the quantum computers to complete operations that classical computers cannot complete, for example, factorization of a quite large natural number. Quantum coherence is essentially utilized in all ultrafast quantum algorithms. Therefore, quantum parallel computations with quantum states replacing classical states can achieve an incomparable computation speed and an incomparable information processing function than the classical computers and also save a large amount of computation resources.

In practical problems, usually, only specific values of an independent variable x E R^{d} and a dependent variable ^{y} ^{∈} ^{R} are known, but a specific form of a multivariable function ^{f:R^{d}} ^{→} ^{R} that results in this change is unknown. Problems of function simulation are problems in which data X ∈ R ^{d} and ^{y} ^{∈} ^{R} are known, and a parameterized model fθ (e.g., a DNN model) that may achieve this change is sought such that it can satisfy ^{|f(x)} ⁻ ^{f}θ ^{(x)} ^{|} ^{<} ^{ε} for any precision ε > 0.

Function simulation is an important problem in the field of artificial intelligence and is widely applied in daily life. With the development of artificial intelligence, a deep neural network (DNN) is widely used to solve the problems of function simulation in daily production and life, such as a stock trend forecast and a weather forecast. However, DNN models require a great number of parameters, and large-scale DNNs often require hundreds of millions of parameters, and may consume a enormous computing resources. In addition, the space of a loss function becomes more complex as the number of parameters increases, in other words, optimization is difficult to perform and the risk of overfitting may be brought. As the quantum computing has developed rapidly in recent years, recent quantum computing devices can already support experiments on some shallow quantum circuits. Therefore, how to utilize the performance advantages of quantum computers over classical computers in terms of learning tasks to solve the problems of function simulation abstracted from daily life is of great significance.

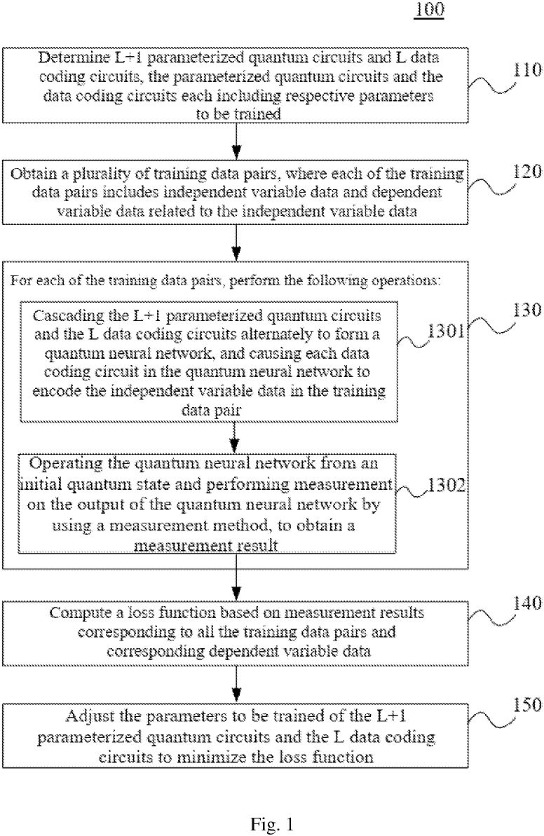

In view of this, a quantum neural network training method according to an embodiment of the present disclosure is proposed. As shown in FIG. 1, the method 100 includes: determining L+1 parameterized quantum circuits and L data encoding circuits, the parameterized quantum circuits and the data encoding circuits each including respective parameters to be trained (step 110); obtaining a plurality of training data pairs, where each of the training data pairs includes independent variable data and dependent variable data related to the independent variable data (step 120); for each of the training data pairs, performing the following operations (step 130): cascading the L+1 parameterized quantum circuits and the L data encoding circuits alternately to form a quantum neural network, and causing each data encoding circuit in the quantum neural network to encode the independent variable data in the training data pair (step 1301); and operating the quantum neural network from an initial quantum state and measuring an obtained quantum state by using a measurement method, to obtain a measurement result (step 1302); computing a value of a loss function based on measurement results corresponding to all the training data pairs and corresponding dependent variable data (step 140); and adjusting the parameters to be trained of the L+1 parameterized quantum circuits and the L data encoding circuits to minimize the loss function (step 150).

In the present disclosure, the independent variable data may include one or more data values. That is, in a data pair containing an independent variable x ∈ R^{d} and a dependent variable y ∈ R as described above, the independent variable ^{x} may be a set of values, for example, x = {x1, x2, x3} .

An embodiment of the present disclosure not only fully uses the computation advantages of quantum computers, but also introduces a trainable data encoding method, which introduces a set of trainable parameters when mapping classical data to a quantum state without a need to specially consider how to design a data encoding circuit. The method may be flexibly extended to a multi-bit case to conveniently simulate a multivariable function.

In the present disclosure, a quantum neural network (QNN) includes a trainable parameterized quantum circuit (PQC). Quantum circuits are the most commonly used description means in the quantum computation field, and may include quantum gates. Each quantum gate operation may be mathematically represented by a unitary matrix.

In the present disclosure, the L+1 parameterized quantum circuits and the L data encoding circuits that are to be trained are cascaded alternately to form a quantum neural network. That is, starting with a parameterized quantum circuit, cascading is sequentially performed on the encoding circuits and the parameterized quantum circuits (ending with a parameterized quantum circuit) to form a quantum neural network as a whole. As an example, for the L+1 parameterized quantum circuits {W⁽⁰⁾(θ₀), W⁽¹⁾(θ₁), ..., W^{(L)}(θ_{L})} and the L data encoding circuits {S⁽¹⁾(ω₁,x),S⁽²⁾(ω₂,x),..., S^{(L)}(ω_{L},x)} used for construction, the mathematical form of the constructed quantum neural network is as follows:

$$U \left(θ , ω , \text{x}\right) = {W}^{\left(L\right)} \left({θ}_{L}\right) {S}^{\left(L\right)} \left({ω}_{L} , \text{x}\right) ⋯ {W}^{\left(1\right)} \left({θ}_{2}\right) {S}^{\left(1\right)} \left({ω}_{1} , \text{x}\right) {W}^{\left(0\right)} \left({θ}_{0}\right)$$

where x is input data, and is an independent variable that needs to be simulated in the problems of function simulation; θ= (θ_{L},...,θ₀), and ω= (ω_{L}, ..., ω₁). Herein, θ_{J} and ωⱼ (j = 0(1), ...,L) are both trainable parameter vectors in the circuits, W(^{j})(θⱼ) are parameterized quantum circuit portions, and S^{(j)}(ωⱼ,x) are data encoding portions.

It should be noted that the specific value of L and the number of qubits used by a quantum circuit may be flexibly designed according to needs, and are not limited herein.

In the present disclosure, an initial quantum state may be any suitable quantum state, for example, ^{|0〉} state, ^{|1〉} state, etc., which is not limited herein.

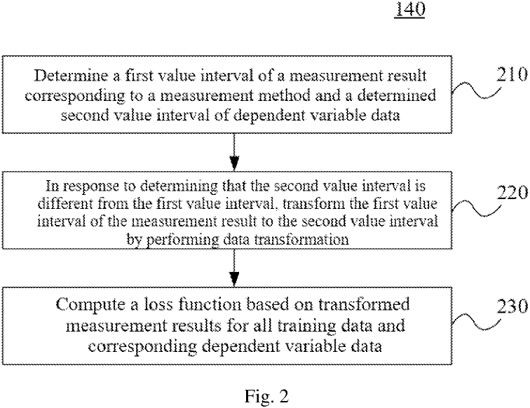

According to some embodiments, as shown in FIG. 2, step 140 may further include: determining a first value interval of the measurement result corresponding to the measurement method and a determined second value interval of the dependent variable data (step 210); in response to determining that the second value interval is different from the first value interval, transforming the first value interval of the measurement result into the second value interval by performing data transformation (step 220); and computing the value of the loss function based on the transformed measurement results for all the training data pairs and corresponding dependent variable data (step 230).

According to some embodiments, the measurement method may include, but is not limited to: Pauli X measurement, Pauli Y measurement and Pauli Z measurement.

For example, in a case of measuring a quantum state after being operated by a first quantum circuit, the Pauli Z measurement can be used to obtain measurement results. Since a result value range of the Pauli Z measurement is within the interval [-1,1], if a value range of a function to be simulated is also within the interval [-1,1], there is no need for performing a data transformation process. If the value range of the function to be simulated is within another

$$\frac{\text{b} - \text{a}}{2} \left〈\text{Z}\right〉 + \frac{\text{b} + \text{a}}{2}$$

interval [a,b], measurement results having a value within the interval [a,b] may be obtained by scaling measurement results (Z) having a value within the interval [-1,1] measured after the operation on the first quantum circuit.

In some examples, the corresponding second value interval, i.e. the value interval of the function to be simulated, may be determined based on the dependent variable data in the plurality of training data pairs. Training data in the problems of function simulation correspond to respective scenarios, for example, a stock trend forecast and a weather forecast. Therefore, based on the training data, a value range of a dependent variable in the function model scenario may be determined. It should be noted that the second value interval may be an approximate value range of the function to be simulated.

In some examples, the independent variable data in the training data pairs are encoded by the data encoding circuits. Herein, the number of qubits of the data encoding circuits may be the same as or different from the amount of independent variable data. That is, the number of qubits of the quantum circuits may be specifically set according to situations, and is not limited herein. A multi-qubit parameterized quantum circuit may have a stronger function simulation capability, and therefore, the multi-qubit parameterized quantum circuit is sometimes considered. Thus, data encoding needs to be performed according to actual situations.

In an example, the input data is x = (x₀,x₁, ^{...} ,xₘ₋₁)^{T} , and the trainable parameters of the data encoding circuits are ω = (ω₀,ω₁, ^{...} , ωₘ₋₁)T, where m is a dimension of the input data. If the data dimension m is greater than the number of qubits n, first, the first n elements (x₀,x₁, ^{...} ,xₙ₋₁)^{T} in the data x may be encoded, then (xₙ,xₙ₊₁, ^{...} ,x₂ₙ₋₁)^{T}, ..., and (^{...},xₘ₋₁,0,^{...},⁰⁾^{T} may be encoded in the same way, and if the data dimension m is exceeded, the data may be padded with 0. It should be understood that the input data (independent variable data) may be encoded using any suitable encoding method, which is not limited herein.

According to some embodiments, the parameters to be trained of the L+1 parameterized quantum circuits and the L data encoding circuits may be adjusted based on a gradient descent method or other optimal methods.

According to some embodiments, the loss function may be constructed based on any suitable algorithm, including, but not limited to, a mean square error, or an absolute value error, etc.

In an embodiment according to the present disclosure, a training data set is

$${\left\{\left({\text{x}}_{i} , {y}_{i}\right)\right\}}_{i = 1}^{M}$$

, ^{x}i is an independent variable of a function, ^{y}i is a function value, and M is the number of data pairs in the training data set. The number of layers of a quantum neural network to be trained, i.e., the number of data encoding circuits, is set to L, and the number of parameterized quantum circuits is one more than that of the data encoding circuits. The number of qubits of the circuits is set to N. The values of L and N may be flexibly set according to needs. The following steps are performed based on the data described above:

Step 1: L+1 parameterized quantum circuits {W⁽⁰⁾(θ₀),W⁽¹⁾(θ₁),...,W^{(L)}(θ_{L})} and L data encoding circuits {S⁽¹⁾(ω₁, x),S⁽²⁾(ω₂,x),..,S^{(L)}(ω_{L},x)} are constructed based on the number N of qubits, where θ and ω are trainable parameters in the circuits, and x is the input independent variable data of the function.

Step 2: for each data pair ^{(x}i^{,y}i⁾ in the training data set, the following steps 3 to 5 are performed.

Step 3: an initial quantum state is set to ^{|0〉} state, which may be expressed by a

$$\left|0\right〉 = \left[\begin{matrix}1 \\ 0 \\ ⋮ \\ 0\end{matrix}\right] .$$

2^{N}-dimensional vector with the first bit 1 and the remaining bits 0, i.e., 0 A parameterized quantum circuit W⁽⁰⁾(θ₀) is operated, and then for all j=1,..., L, data encoding circuits ^{S}^{(j)(ω}j^{,x}i⁾ and parameterized quantum circuits ^{W}^{(j)(θ}j⁾ are performed alternately, where all these circuits to be trained are denoted as ^{U(θ,}^{ω,}^{x}i⁾ as a whole, i.e., the quantum neural network to be trained.

Step 4: after all the circuits are sequentially operated, the quantum state obtained through operation is measured to obtain expected values, for example, 〈Z)ᵢ=〈0|U^{†}(θ,ω,xᵢ)(Z ⊗ I ⊗ ^{...} ⊗ I)U(θ,ω,xi)|0〉, used as a predicted function output value, where U^{†} represents a conjugate transpose of U, and Z ⊗ I ⊗ ^{...} ⊗ I is a tensor product

$$Z = \left[\begin{matrix}1 & 0 \\ 0 & - 1\end{matrix}\right]$$

of a Pauli matrix and N-1 identity matrices

$$I = \left[\begin{matrix}1 & 0 \\ 0 & 1\end{matrix}\right]$$

, representing measurement of the first qubit of the quantum state obtained through operation.

Step 5: a squared error Lᵢ(ω,θ) = |〈Z〉ᵢ - yᵢ|² between the predicted value 〈Z〉ᵢ and a real value yᵢ is computed.

Step 6: after the steps described above are completed, for all the data (xᵢ,yᵢ) in the training data set, the mean square error

$$L \left(ω , θ\right) = \frac{1}{M} {\sum }_{i = 1}^{M} {L}_{i}$$

is calculated as a loss function.

Step 7: the parameters 0 and ωin the circuits are adjusted by using a gradient descent method or other optimization methods, and steps 2 to 7 are repeated until the loss function L does not further decreases or a set number of iterations is reached, where parameters obtained at this point are denoted as θ* and ω*.

Step 8: the optimized parameterized quantum circuits [symbol] and data encoding circuits

$$\left\{{S}^{\left(1\right)} \left({ω}_{1}^{∗} , \text{x}\right) , {S}^{\left(2\right)} \left({ω}_{2}^{∗} , \text{x}\right) , … , {S}^{\left(L\right)} \left({ω}_{L}^{∗} , \text{x}\right)\right\}$$

form a trained quantum function simulator, and this can be used as an output according to the present embodiment.

In the embodiment described above, although an excepted value of an observable Z ⊗ I ⊗ ^{...} ⊗ I is selected as a prediction of a QNN, it may be understood that, other

$$X = \left[\begin{matrix}0 & 1 \\ 1 & 0\end{matrix}\right]$$

appropriate observables, for example, X ⊗ Z ⊗ ^{...}⊗ Y , where and

$$Y = \left[\begin{matrix}0 & - i \\ i & 0\end{matrix}\right]$$

are Pauli matrices and i is an imaginary unit, may also be selected according to hardware devices used specifically and application scenarios. In addition, the initial quantum state of a quantum neural network is not limited to the ^{|0〉} state, which is merely exemplary herein, and any other suitable quantum states are possible.

According to a method of the present disclosure, trainable parameters are introduced in data encoding circuits, and therefore, there is neither a need to specially consider a data encoding circuit structure transforming classical data to the quantum state, nor a need to design special parameterized quantum circuits, and the only need is to provide the model with training data. The method may be flexibly extended to a multi-qubit case to conveniently simulate a multivariable function.

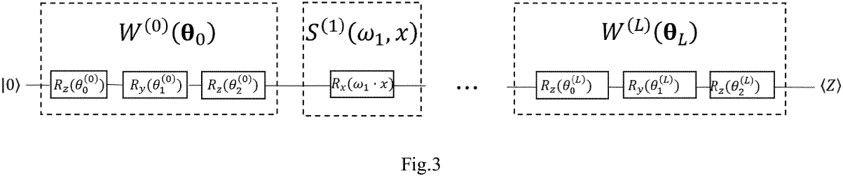

In an exemplary application, based on the method of the present disclosure, a function is simulated as follows:

$$f \left(x\right) = \frac{sin \left(5 π \text{} x\right)}{5 π \text{} x} , x ∈ \left(0 , 1\right)$$

where a quantum neural network to be trained (including parameterized quantum circuits and data encoding circuits) may be shown in FIG. 3. The quantum circuit is a single-qubit QNN model. The parameterized quantum circuit W^{(j)}(θⱼ) is formed by three quantum gates

$${R}_{z} \left({θ}_{0}^{\left(j\right)}\right) , {R}_{y} \left({θ}_{1}^{\left(j\right)}\right) , \text{and} {R}_{z} \left({θ}_{2}^{\left(j\right)}\right)$$

,where

$${θ}_{k}^{\left(j\right)} , k = 0 , 1 , 2$$

are parameters of the quantum gates, which are all scalar quantities. The data encoding circuit S^{(j)}(ωⱼ,χ) includes a quantum gate Rₓ(ωⱼχ), where ^{ω}ⱼ, are both scalar quantities. A depth of the quantum neural network is denoted as L, and an expected value ^{〈Z〉} is used as an output of the model.

In another exemplary application, based on the method of the present disclosure, a multivariable function generated randomly by a Gaussian process is simulated, whose specific form is:

$$f \left(\text{x}\right) = \text{k} {\left(\text{x}\right)}^{T} {K}^{- 1} \text{b}$$

where k(x)^{T}= (k(x,a₁), ... k(x,aₘ))^{T} is a vector, k is a given kernel function, and K is a kernel matrix, whose matrix elements are Kᵢⱼ = k(aᵢ,aⱼ), with aᵢ ∈ R^{d} being a series of random data points, and b = (b₁, ..., bₘ) ∈ R^{m} is random function values corresponding to these random data points.

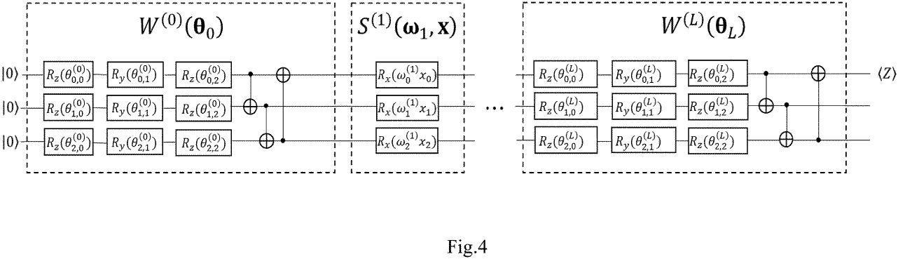

In this application, the dimension of the input data x is 2 or 3. Accordingly, two-qubit and three-qubit QNN models may be used. Certainly, QNN models to be trained having other number of qubits are also possible, which is not limited herein. FIG. 4 illustrates a three-qubit QNN quantum circuit. A two-qubit quantum circuit is similar. As shown in FIG. 4, construction of a parameterized quantum circuit W^{(j)}(θⱼ) contains two steps: 1) three quantum

$${R}_{z} \left({θ}_{i , 0}^{\left(j\right)}\right) , {R}_{y} \left({θ}_{i , 1}^{\left(j\right)}\right) , \text{and} {R}_{z} \left({θ}_{i , 2}^{\left(j\right)}\right)$$

gates are performed successively on each qubit i, where

$${θ}_{i , k}^{\left(j\right)} , k = 0 , 1 , 2 , i = 0 , 1 , 2$$

are parameters of the quantum gates, which are all scalar quantities; and 2) a controlled NOT gate (CNOT), i.e. the “ [symbol] ” operation in FIG. 4, is performed on qubit pairs (0, 1), (1, 2), and (2, 0). Construction of a data encoding circuit S⁽ⁱ⁾(wⱼ,x) needs to operate a quantum gate

$${R}_{x} \left({ω}_{i}^{\left(j\right)} {x}_{i}\right)$$

on each qubit i.

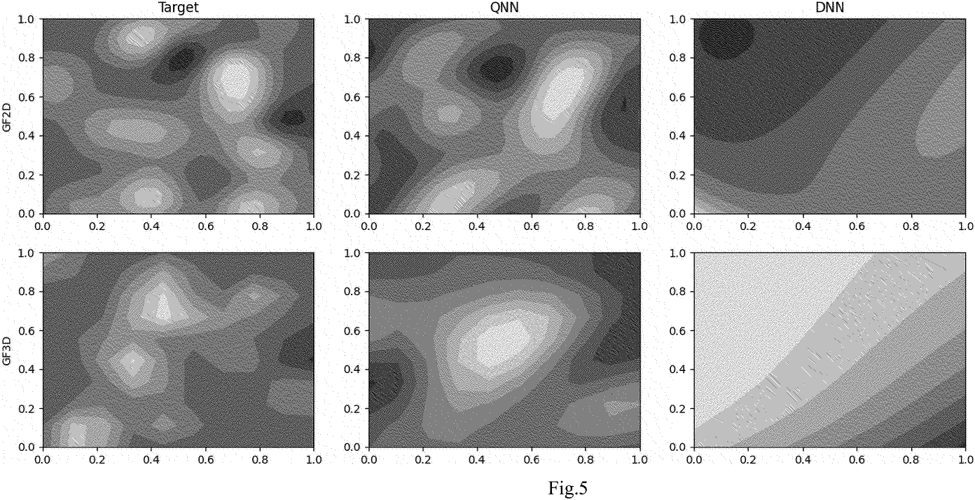

Simulation results of this application is shown in FIG. 5, where “Target” represents the function needs to be simulated, “DNN” represents simulation results of a classical DNN model, “QNN” represents simulation results of the QNN model of the present disclosure, and “GF2D” and “GF3D” respectively correspond to a binary function and a ternary function, i.e., the input data x of which is a two- and three-dimensional vector respectively, randomly generated by the Gaussian process. The first two dimensions of the input data x are used in FIG. 5.

In the applications described above, when the simulation effect of a classical DNN network is compared with that of the method of the present disclosure, the latter is significantly better than the former. The number of parameters used by the method of the present disclosure are less, and therefore the resources used are less. In addition, under a same iteration condition, the method of the present disclosure has higher precision, practicability, and effectiveness.

According to an embodiment of the present disclosure, as shown in FIG. , 6, there is further provided a quantum neural network training system 600, including: a quantum computer 610 configured to: determine L+1 parameterized quantum circuits and L data encoding circuits, the parameterized quantum circuits and the data encoding circuits each including respective parameters to be trained, where L is a positive integer; for each of a plurality of training data pairs, where each of the training data pairs includes independent variable data and dependent variable data related to the independent variable data, wherein the independent variable data includes one or more data values, perform the following operations: cascading the L+1 parameterized quantum circuits and the L data encoding circuits alternately to form a quantum neural network, and causing each data encoding circuit in the quantum neural network to code the independent variable data in the training data pair; and operating the quantum neural network from an initial quantum state and measuring an obtained quantum state by using a measurement method, to obtain a measurement result; and a classical computer 620 configured to: compute a loss function based on measurement results corresponding to all the training data pairs and corresponding dependent variable data; and adjust the parameters to be trained of the L+1 parameterized quantum circuits and the L data encoding circuits to minimize the loss function.

Herein, operations of all the foregoing units of the quantum neural network training system 600 are similar to operations of steps 110 to 150 described above. Details are not described herein again.

According to the embodiments of the present disclosure, there are further provided an electronic device, a readable storage medium and a computer program product.

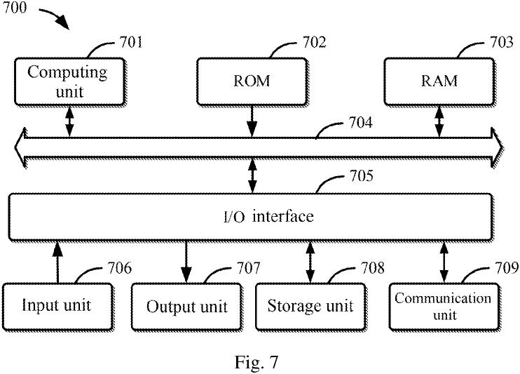

Referring to FIG. 7, a structural block diagram of an electronic device 700 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 7, the electronic device 700 includes a computing unit 701, which may perform various appropriate actions and processing according to a computer program stored in a read-only memory (ROM) 702 or a computer program loaded from a storage unit 708 to a random access memory (RAM) 703. The RAM 703 may further store various programs and data required for the operation of the electronic device 700. The computing unit 701, the ROM 702, and the RAM 703 are connected to each other through a bus 704. An input/output (I/O) interface 705 is also connected to the bus 704.

A plurality of components in the electronic device 700 are connected to the I/O interface 705, including: an input unit 706, an output unit 707, the storage unit 708, and a communication unit 709. The input unit 706 may be any type of device capable of entering information to the electronic device 700. The input unit 706 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 707 may be any type of device capable of presenting information, and may include, but is not limited to, a display, a speaker, a video/audio output terminal, a vibrator, and/or a printer. The storage unit 708 may include, but is not limited to, a magnetic disk and an optical disc. The communication unit 709 allows the electronic device 700 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth®™ device, an 802.11 device, a Wi-Fi device, a WiMAX device, a cellular communication device, and/or the like.

The computing unit 701 may be various general-purpose and/or special-purpose processing components with processing and computing capabilities. Some examples of the computing unit 701 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 701 performs the various methods and processing described above, for example, the method 100. For example, in some embodiments, the method 100 may be implemented as a computer software program, which is tangibly contained in a machine-readable medium, such as the storage unit 708. In some embodiments, a part or all of the computer program may be loaded and/or installed onto the electronic device 700 via the ROM 702 and/or the communication unit 709. When the computer program is loaded onto the RAM 703 and executed by the computing unit 701, one or more steps of the method 100 described above can be performed. Alternatively, in other embodiments, the computing unit 701 may be configured, by any other suitable means (for example, by means of firmware), to perform the method 100.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely exemplary embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computer-implemented method, comprising:
determining L+1 parameterized quantum circuits and L data encoding circuits, the parameterized quantum circuits and the data encoding circuits each comprising a respective parameter to be trained, where L is a positive integer;
obtaining a plurality of training data pairs, wherein each of the plurality of training data pairs comprises independent variable data and dependent variable data related to the independent variable data, and wherein the independent variable data comprises one or more data values;
for each of the plurality of training data pairs, performing the following operations:
cascading the L+1 parameterized quantum circuits and the L data encoding circuits alternately to form a quantum neural network, and causing each of the L data encoding circuits in the quantum neural network to encode the independent variable data in the training data pair; and
operating the quantum neural network from an initial quantum state and performing measurement on the output of the quantum neural network by using a measurement method, to obtain a measurement result;
computing a value of a loss function based on the measurement results corresponding to all the training data pairs and corresponding dependent variable data; and
adjusting the parameters to be trained of the L+1 parameterized quantum circuits and the L data encoding circuits to minimize the value of the loss function.

2. The method according to claim 1, wherein the computing a value of a loss function based on the measurement results corresponding to all the training data pairs and corresponding dependent variable data comprises:
determining a first value interval of the measurement result corresponding to the measurement method and a determined second value interval of the dependent variable data;
in response to determining that the second value interval is different from the first value interval, transforming the first value interval of the measurement result into the second value interval; and
computing the value of the loss function based on the transformed measurement results for all the training data pairs and the corresponding dependent variable data.

3. The method according to claim 1, wherein the measurement method comprises at least one of: Pauli X measurement, Pauli Y measurement, and Pauli Z measurement.

4. The method according to claim 1, wherein the parameters to be trained of the L+1 parameterized quantum circuits and the L data encoding circuits are adjusted based on a gradient descent method.

5. An electronic device, comprising:
a memory storing one or more programs configured to be executed by one or more processors, the one or more programs including instructions for causing the electronic device to perform operations comprising:
determining L+1 parameterized quantum circuits and L data encoding circuits, the parameterized quantum circuits and the data encoding circuits each comprising a respective parameter to be trained, where L is a positive integer;
obtaining a plurality of training data pairs, wherein each of the plurality of training data pairs comprises independent variable data and dependent variable data related to the independent variable data, and wherein the independent variable data comprises one or more data values;
for each of the plurality of training data pairs, performing the following operations:
cascading the L+1 parameterized quantum circuits and the L data encoding circuits alternately to form a quantum neural network, and causing each of the L data encoding circuits in the quantum neural network to encode the independent variable data in the training data pair; and
operating the quantum neural network from an initial quantum state and performing measurement on the output of the quantum neural network by using a measurement method, to obtain a measurement result;
computing a value of a loss function based on the measurement results corresponding to all the training data pairs and corresponding dependent variable data; and
adjusting the parameters to be trained of the L+1 parameterized quantum circuits and the L data encoding circuits to minimize the value of the loss function.

6. The electronic device according to claim 5, wherein the computing a value of a loss function based on the measurement results corresponding to all the training data pairs and corresponding dependent variable data comprises:
determining a first value interval of the measurement result corresponding to the measurement method and a determined second value interval of the dependent variable data;
in response to determining that the second value interval is different from the first value interval, transforming the first value interval of the measurement result into the second value interval; and
computing the value of the loss function based on the transformed measurement results for all the training data pairs and the corresponding dependent variable data.

7. The electronic device according to claim 5, wherein the measurement method comprises at least one of: Pauli X measurement, Pauli Y measurement, and Pauli Z measurement.

8. The electronic device according to claim 5, wherein the parameters to be trained of the L+1 parameterized quantum circuits and the L data encoding circuits are adjusted based on a gradient descent method.

9. A non-transitory computer-readable storage medium that stores one or more programs comprising instructions that, when executed by one or more processors of a computing device, cause the computing device to implement operations comprising:
determining L+1 parameterized quantum circuits and L data encoding circuits, the parameterized quantum circuits and the data encoding circuits each comprising a respective parameter to be trained, where L is a positive integer;
obtaining a plurality of training data pairs, wherein each of the plurality of training data pairs comprises independent variable data and dependent variable data related to the independent variable data, and wherein the independent variable data comprises one or more data values;
for each of the plurality of training data pairs, performing the following operations:
cascading the L+1 parameterized quantum circuits and the L data encoding circuits alternately to form a quantum neural network, and causing each of the L data encoding circuits in the quantum neural network to encode the independent variable data in the training data pair; and
operating the quantum neural network from an initial quantum state and performing measurement on the output of the quantum neural network by using a measurement method, to obtain a measurement result;
computing a value of a loss function based on the measurement results corresponding to all the training data pairs and corresponding dependent variable data; and
adjusting the parameters to be trained of the L+1 parameterized quantum circuits and the L data encoding circuits to minimize the value of the loss function.

10. The non-transitory computer-readable storage medium according to claim 9, wherein the computing a value of a loss function based on the measurement results corresponding to all the training data pairs and corresponding dependent variable data comprises:
determining a first value interval of the measurement result corresponding to the measurement method and a determined second value interval of the dependent variable data;
in response to determining that the second value interval is different from the first value interval, transforming the first value interval of the measurement result into the second value interval; and
computing the value of the loss function based on the transformed measurement results for all the training data pairs and the corresponding dependent variable data.

11. The non-transitory computer-readable storage medium according to claim 9, wherein the measurement method comprises at least one of: Pauli X measurement, Pauli Y measurement, and Pauli Z measurement.

12. The non-transitory computer-readable storage medium according to claim 9, wherein the parameters to be trained of the L+1 parameterized quantum circuits and the L data encoding circuits are adjusted based on a gradient descent method.
